(19) United States
(12) Patent Application Publication
(10) Pub. No.: US 2024/0328858 A1
(43) Pub. Date: Oct. 3, 2024

(54) APPARATUS AND METHOD FOR DETECTING DYE MIXING RATIO

(71) Applicant: ELECTRONICS AND TELECOMMUNICATIONS RESEARCH INSTITUTE, Daejeon (KR)

(72) Inventors: Hyun Woo OH, Daejeon (KR); Ji Yong HWANG, Daejeon (KR)

(21) Appl. No.: 18/619,457

(22) Filed: Mar. 28, 2024

(30) Foreign Application Priority Data
Mar. 29, 2023 (KR) 10-2023-0041440

(51) Int. Cl. G01J 3/46

(52) U.S. Cl. CPC G01J 3/462; G01J 3/463

(57) ABSTRACT

The present invention relates to an apparatus and method for detecting a dye mixing ratio, and the apparatus for detecting a dye mixing ratio includes a storage unit configuration to store computer color matching (CCM) colorimetric data for each dye concentration, and a processor configuration to convert the CCM colorimetric data for each dye concentration store in the storage unit into absorbance data and detect a dye mixing ratio that matches an absorbance graph of a buyer order, on the basis of an artificial intelligence model.

### CROSS-REFERENCE TO RELATED APPLICATION

This application claims priority to and the benefit of Korean Patent Application No. 10-2023-0041440, filed on Mar. 29, 2023, the disclosure of which is incorporated herein by reference in its entirety.

### BACKGROUND

### 1. Field of the Invention

The present invention relates to an apparatus and method for detecting a dye mixing ratio.

### 2. Description of Related Art

Buyer orders contain ordering information on color, touch sensation, etc., that buyers require for desired fabric. The buyer order provides a color chip that can be considered as a swatch sample and the type of corresponding fabric, or provides a QuickTime extension (QTX) file, which is a result obtained by the buyer measuring color using a computer color matching (CCM) colorimeter under specific light source conditions, along with a swatch sample.

In CCM colorimetry, various light source conditions (D65, U35, A/10, etc.) can be set, and when colorimetry is performed on a specific fabric under corresponding light source conditions, values such as a reflectance, an XYZ color space value, a K/S value, and the like under the corresponding light source conditions are measured.

A method in which a CCM colorimeter and operating software (SW) are used is as follows. The dyes used can vary depending on the dyeing factory. Accordingly, basic data can be present.

Basic data includes values measured by a CCM colorimeter under specific light source conditions by dyeing fabric at different concentrations with dyes used in a corresponding factory. Since there are so many different types and colors of fabric requested by buyers, about five types of basic data are generated at the concentration for each dye. Further, the basic data is generated by dyeing 100% cotton fabric.

When basic data is input by subdividing all types of fabric and concentrations for all dyes, very good results may be obtained, but this is realistically difficult in the field. In the case in which the basic data is input and managed in this way, when a new buyer's order is received and a QTX file is uploaded or a color chip is measured with a CCM colorimeter, a color, a reflectance, XYZ values, and the like for the corresponding order may be visualized and provided.

In order to reproduce a color ordered by a buyer, in the field, an operator selects three to six monochromatic dyes that are being used in a corresponding factory and calculates dye mixing prescription through simulation. The dye mixing prescription is intended for simulation on the basis of previously input basic data. B/T testing is conducted based on several dye mixing prescriptions recommended through simulation in this way. It is checked whether the color is reproduced in the B/T test, and when the color is reproduced through the B/T test, the corresponding dye mixing prescription is issued to the site through a prescription. However, since dyeing in the field is not dyeing at a laboratory level, scale up occurs and a color difference occurs due to various factors. When a color difference occurs, the color difference is corrected by comparing the color with buyer order data through CCM colorimetry and utilizing information regarding a deviation.

The related art of the present invention is disclosed in Korean Patent Registration No. 10-2035059 (published on Oct. 16, 2019).

### SUMMARY OF THE INVENTION

The present invention is directed to providing an apparatus and method for detecting a dye mixing ratio, in which an absorbance graph is generated using a QuickTime extension (QTX) reflectance and a dye mixing ratio is detected based on the generated absorbance graph.

According to an aspect of the present disclosure, there is provided an apparatus for detecting a dye mixing ratio, which includes a storage unit configuration to store computer color matching (CCM) colorimetric data for each dye concentration, and a processor configuration to convert the CCM colorimetric data for each dye concentration store in the storage unit into absorbance data and detect a dye mixing ratio that matches an absorbance graph of a buyer order, on the basis of an artificial intelligence model.

The CCM colorimetric data for each dye concentration may be a CCM colorimetric QTX reflectance for each dye concentration.

The processor may convert a reflectance under buyer-order light source conditions into an absorbance and calculate a slope for each wavelength section of the absorbance data to use the calculated slope as rising and falling trend information of the absorbance graph, and calculate an absorbance area in a specific absorbance wavelength section to use the calculated area as information on a color intensity.

The processor may convert XYZ values under buyer-order light source conditions into standard red, green, and blue (sRGB) values and calculate a color intensity and a K/S value on the basis of the sRGB values.

The processor may generate the absorbance graph on the basis of a ratio of monochromatic dyes, generate an absorbance graph of a mixed dye that is calculated by summation when the monochromatic dyes are mixed, and detect the dye mixing ratio that matches the absorbance graph of the buyer order.

The processor may construct a training dataset for the artificial intelligence model to train the artificial intelligence model, and apply a test dataset to the artificial intelligence model to detect the dye mixing ratio.

The training dataset may include at least one of an absorbance according to dye combination, a slope by wavelength, an absorbance area, RGB colors, a color intensity, and a K/S value as an input value of the training dataset, and include at least one of a dye code, a dye mixing ratio, and a total concentration as an output value of an answer sheet of the training dataset.

The test dataset may include at least one of a buyer order absorbance, a slope by wavelength, an absorbance area, RGB colors, a color intensity, and a K/S value as an input value of the test dataset, and include at least one of a dye code, a dye mixing ratio, and a total concentration as an output value of the test dataset.

The processor may convert a reflectance of the CCM colorimetric data for each dye concentration into an absorbance to use the absorbance as basic data for the dye mixing ratio, calculate the number of possible combinations of dye mixing ratios, calculate a combination for each combined monochromatic dye ratio to construct the training dataset, and obtain the dye mixing ratio through a combination of the combined monochromatic dye ratios and calculate a dye mixing concentration to construct an answer sheet for training to proceed with training of the artificial intelligence model.

The processor may calculate the number of possible cases with a plurality of dye combinations, calculate the number of cases for a plurality of concentration intervals for the calculated number of cases, then calculate an absorbance graph of a monochromatic dye and an absorbance graph of the mixed dye for a dye mixing ratio presented in numbers in each case, generate a training dataset for the absorbance graph of the mixed dye, and use the dye mixing ratio as an answer sheet.

According to another aspect of the present disclosure, there is provided a method of detecting a dye mixing ratio, which includes collecting, by a processor, CCM colorimetric data for each dye concentration, and converting, by the processor, the CCM colorimetric data for each dye concentration into absorbance data and detecting a dye mixing ratio that matches an absorbance graph of a buyer order, on the basis of an artificial intelligence model.

The CCM colorimetric data for each dye concentration may be a CCM colorimetric QTX reflectance for each dye concentration.

In the detecting of the dye mixing ratio, the processor may convert a reflectance under buyer-order light source conditions into an absorbance and calculate a slope for each wavelength section of the absorbance data to use the calculated slope as rising and falling trend information of the absorbance graph, and calculate an absorbance area in a specific absorbance wavelength section to use the calculated area as information on a color intensity.

In the detecting of the dye mixing ratio, the processor may convert XYZ values under buyer-order light source conditions into sRGB values and calculate a color intensity and a K/S value on the basis of the sRGB values.

In the detecting of the dye mixing ratio, the processor may generate the absorbance graph on the basis of a ratio of monochromatic dyes, generate an absorbance graph of a mixed dye that is calculated by summation when the monochromatic dyes are mixed, and detect the dye mixing ratio that matches the absorbance graph of the buyer order.

In the detecting of the dye mixing ratio, the processor may construct a training dataset for the artificial intelligence model to train the artificial intelligence model, and apply a test dataset to the artificial intelligence model to detect the dye mixing ratio.

The training dataset may include at least one of an absorbance according to dye combination, a slope by wavelength, an absorbance area, RGB colors, a color intensity, and a K/S value as an input value of the training dataset, and include at least one of a dye code, a dye mixing ratio, and a total concentration as an output value of an answer sheet of the training dataset.

The test dataset may include at least one of a buyer order absorbance, a slope by wavelength, an absorbance area, RGB colors, a color intensity, and a K/S value as an input value of the test dataset, and include at least one of a dye code, a dye mixing ratio, and a total concentration as an output value of the test dataset.

In the detecting of the dye mixing ratio, the processor may convert a reflectance of the CCM colorimetric data for each dye concentration into an absorbance to use the absorbance as basic data for the dye mixing ratio, calculate the number of possible combinations of dye mixing ratios, calculate a combination for each combined monochromatic dye ratio to construct the training dataset, and obtain the dye mixing ratio through a combination of the combined monochromatic dye ratios and calculate a dye mixing concentration to construct an answer sheet for training to proceed with training of the artificial intelligence model.

In the detecting of the dye mixing ratio, the processor may calculate the number of possible cases with a plurality of dye combinations, calculate the number of cases for a plurality of concentration intervals for the calculated number of cases, then calculate an absorbance graph of a monochromatic dye and an absorbance graph of the mixed dye for a dye mixing ratio presented in numbers in each case, generate a training dataset for the absorbance graph of the mixed dye, and use the dye mixing ratio as an answer sheet.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of an apparatus for detecting a dye mixing ratio according to an embodiment of the present invention;

FIG. 2 is a conceptual diagram showing the operation of a processor according to an embodiment of the present invention;

FIG. 3 is a block diagram showing components of a training dataset for a buyer order according to an embodiment of the present invention;

FIG. 4 is a diagram showing partial contents of a QuickTime extension (QTX) file as a result of computer color matching (CCM) colorimetry according to an embodiment of the present invention;

FIG. 5 is a diagram showing an example of matching a buy order absorbance through an absorbance conversion graph for a buy order QTX reflectance and an absorbance graph of an arbitrary dye mixing ratio according to an embodiment of the present invention;

FIG. 6 is a diagram showing absorbance graph conversion according to a dye mixing ratio and an absorbance graph as a mixed dye thereof according to an embodiment of the present invention;

FIG. 7 is a diagram showing a process of generating an absorbance graph and generating a training dataset for the generated absorbance graph according to an embodiment of the present invention;

FIG. 8 is a diagram showing a training dataset for training a dye mixing ratio recommendation artificial intelligence (AI) model based on absorbance dataset augmentation according to an embodiment of the present invention; and

FIG. 9 is a diagram showing an AI model according to an embodiment of the present invention.

### DETAILED DESCRIPTION OF EXEMPLARY EMBODIMENTS

Hereinafter, examples of an apparatus and method for detecting a dye mixing ratio according to embodiments of the present invention will be described. In this process, thicknesses of lines, sizes of components, and the like shown in the accompanying drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

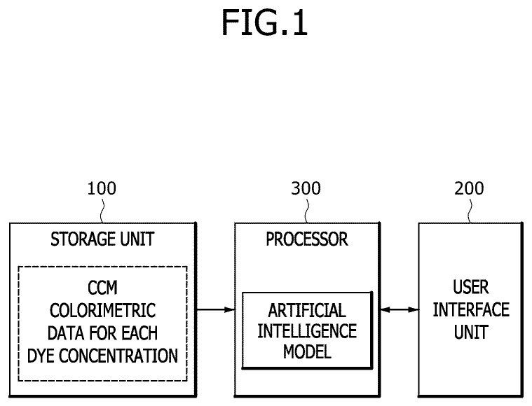

FIG. 1 is a block diagram of an apparatus for detecting a dye mixing ratio according to an embodiment of the present invention.

Referring to FIG. 1, the apparatus for detecting a dye mixing ratio according to the embodiment of the present invention includes a storage unit 100, a user interface unit 200, and a processor 300.

In the storage unit 100, computer color matching (CCM) colorimetric data for each dye concentration is stored. The CCM colorimetric data may be measured by a CCM colorimeter or stored in advance. In the case in which the CCM colorimetric data is stored in advance, a dye mixing ratio may be generated by a buyer order even when CCM colorimetry is not performed separately.

In the storage unit 100, a training dataset and a test dataset for an artificial intelligence (AI) model may be stored. The training dataset and the test dataset will be described below.

In the storage unit 100, data required for the operation of the processor 300 may be stored.

Data stored in the storage unit 100 may be selected by the processor 300.

The storage unit 100 may be a non-volatile memory, in which stored information is continuously maintained even without the supply of power, and a volatile memory, in which power is required to maintain stored information. The storage unit 100 may be a magnetic storage medium or flash storage medium in addition to a volatile storage device in which power is required to maintain data.

The user interface unit 200 provides a user interface for detecting a dye mixing ratio. For example, the user interface unit 200 may input data or control commands necessary for the processor 300 to detect a dye mixing ratio to the processor 300. The user interface unit 200 may output a result of detecting the dye mixing ratio by the processor 300.

For example, the user interface unit 200 may be provided as a user interface such as a keyboard, a mouse, a touch pad, a touch screen, an electronic pen, a touch button, or the like. Further, the user interface unit 200 may include a printer, a display, etc., to output data. Here, the display may be implemented as, for example, a thin-film-transistor liquid-crystal display (TFT LCD) panel, a light-emitting diode (LED) panel, an organic LED (OLED) panel, an active-matrix OLED (AMOLED) panel, a flexible panel, or the like.

The processor 300 collects a CCM colorimetric QuickTime extension (QTX) reflectance for each dye concentration. The processor 300 may convert the collected CCM colorimetric QTX reflectance for each dye concentration into absorbance data, and extracts a dye mixing ratio that matches an absorbance graph of the buyer order, that is, a target absorbance graph, on the basis of the absorbance data.

The processor 300 outputs the extracted dye mixing ratio through the user interface unit 200.

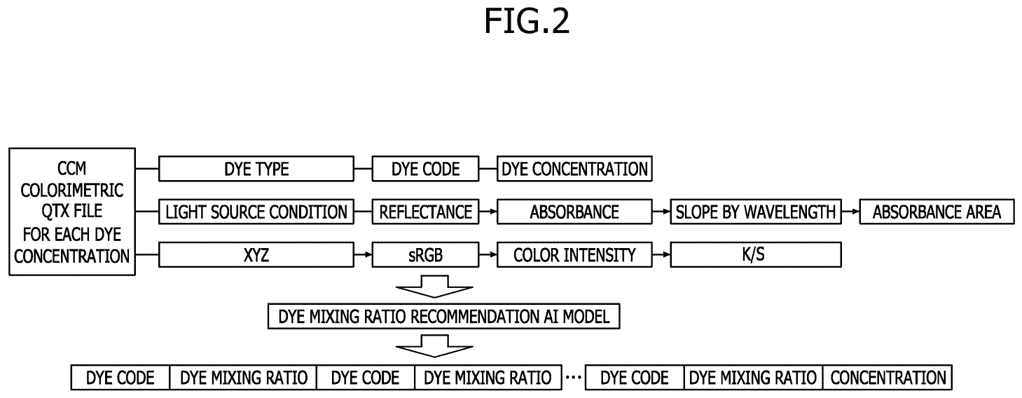

FIG. 2 is a conceptual diagram showing the operation of the processor 300 according to the embodiment of the present invention.

FIG. 2 conceptually shows a process in which the processor 300 converts CCM colorimetric data for each dye concentration into absorbance data and detects a dye mixing ratio that matches an absorbance graph of a buyer order on the basis of the absorbance data. The processor 300 collects the CCM colorimetric data for each dye concentration from a storage unit 100.

The CCM colorimetric data for each dye concentration may be a CCM colorimetric QTX reflectance for each dye concentration. The CCM colorimetric data for each dye concentration may be held on site at a dye company or dyeing factory.

The processor 300 converts a reflectance into an absorbance and calculates a slope for each wavelength section on the basis of data obtained by measuring a color through CCM under light source conditions for each dye and concentration.

The processor 300 may calculate an absorbance area in a certain wavelength section, convert XYZ values into standard red, green, and blue (sRGB) values, and calculate a color intensity and a K/S value on the basis of RGB values to form a training dataset.

The processor 300 outputs a dye mixing ratio and a concentration through an AI model that can recommend the dye mixing ratio.

An expression for converting a reflectance into absorbance data may be absorbance (A)=−log R or absorption rate (% A)−(1/log (% R))+α. A difference between the absorbance and the absorption rate may be a difference whether a reflectance is applied as a percentage or decimal, and portion a of the absorption rate may be regarded as a value for the intercept.

When absorbance data is given, the sharpness of color may vary depending on whether an absorbance graph rises or falls gradually or rises or falls rapidly. Therefore, the processor 300 may calculate a slope for each wavelength section to generate data for the slope value, and secure distinguishable data in addition to the absorbance data through a process of training the generated data.

Further, the entire absorbance area is related to a color intensity or concentration. Therefore, the processor 300 calculates an area of an absorbance graph within a certain wavelength section and uses the calculated area as other distinguishable data.

Since XYZ values in the color space are obtained when CCM colorimetry is performed, the processor 300 may convert the corresponding XYZ values into sRGB values through a conversion matrix.

Given the RGB values mean that a color intensity can be calculated through an expression used by the color science, and thus the processor 300 may also derive a K/S value through CCM colorimetry.

These calculated values may be data items that can increase training accuracy in a process of training an AI model.

The processor 300 may be equipped with an AI model that can be used in the dyeing field by increasing training accuracy by adding available data items. Further, an AI model for recommending a dye mixing ratio that is trained in this way may be trained based on QTX files obtained from dye companies, even in factories that do not have a CCM colorimeter and operating software (SW), and may output the dye mixing ratio that can reproduce the color for the buyer order. Therefore, the AI model may be used in many small and medium-sized dyeing factories and dyeing factories in underdeveloped countries.

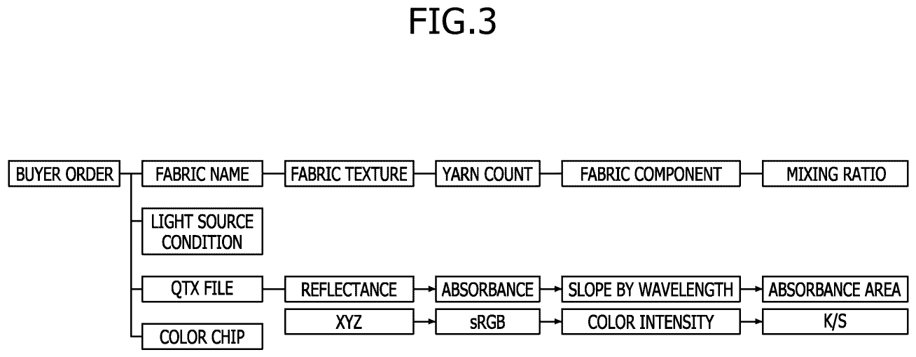

FIG. 3 is a block diagram showing components of a training dataset for a buyer order according to an embodiment of the present invention.

Referring to FIG. 3, the buyer order may request dyeing and processing of a specific fabric with the desired color and touch sensation.

Conventionally, for a specific fabric, only a fabric name is presented, but there are many factors that can determine fabric characteristics such as fabric texture, a yarn count, fabric components, a mixing ratio, and the like. In the present embodiment, the influence of fabric characteristics is not considered because it is a factor ignored in CCM colorimetry.

The buyer order may provide a QTX file or may be provided through a color chip. Both of these cases may be confirmed through CCM colorimetry, and a reflectance and XYZ values in the color space may be obtained through CCM colorimetry.

The processor 300 may convert reflectance data into absorbance data through an expression such as absorbance (A)=−log R, absorption rate (% A)=(1/log(% R))+α, or the like.

The absorbance data may be represented in a graph and used to obtain a slope value through a difference in data between wavelengths.

The slope value is data that can confirm the trend of the absorbance graph. The entire absorbance area may be calculated based on absorbance data in a certain range (400 nm to 700 nm). The XYZ values may be converted into sRGB data and may also be used to obtain a color intensity value. A color temperature may be used instead of a color intensity. Brightness may be used as other usable data.

Here, data to be additionally used may be selectively used.

In the present embodiment, the color intensity may be calculated and added in consideration of an effect on a dyeing concentration.

Further, the K/S value is very important in the dyeing process because it is important to determine how much of a dye solution is absorbed into fabric and dyed. Therefore, the processor 300 uses the K/S value according to CCM colorimetry to construct a dataset for training an AI model.

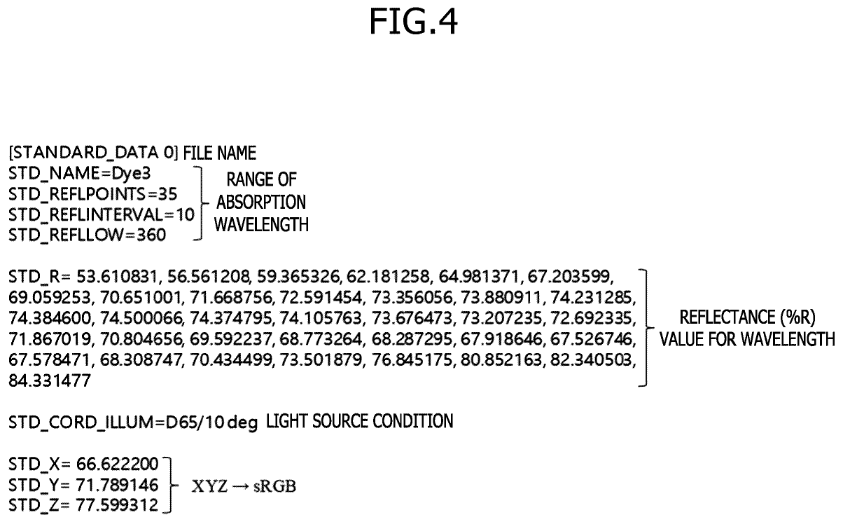

FIG. 4 is a diagram showing partial contents of a QTX file as a result of CCM colorimetry according to an embodiment of the present invention.

Referring to FIG. 4, STD_NAME represents a dye name.

STD_REFLPOINT represents that the number of colorimetric points is 35.

STD REFLINTERVAL represents that a wavelength interval is 10 nm.

STD_REFLLOW represents a colorimetric start wavelength. That is, it represents a result of measuring 35 points at 10 nm intervals from a wavelength of 360 nm to a wavelength of 700 nm.

STD_R represents a reflectance value of 35 points.

STD_CORD_ILLUM represents CCM colorimetry light source conditions and represents D65/10 degree.

STD_X, STD_Y, and STD_X represent XYZ values in the color space.

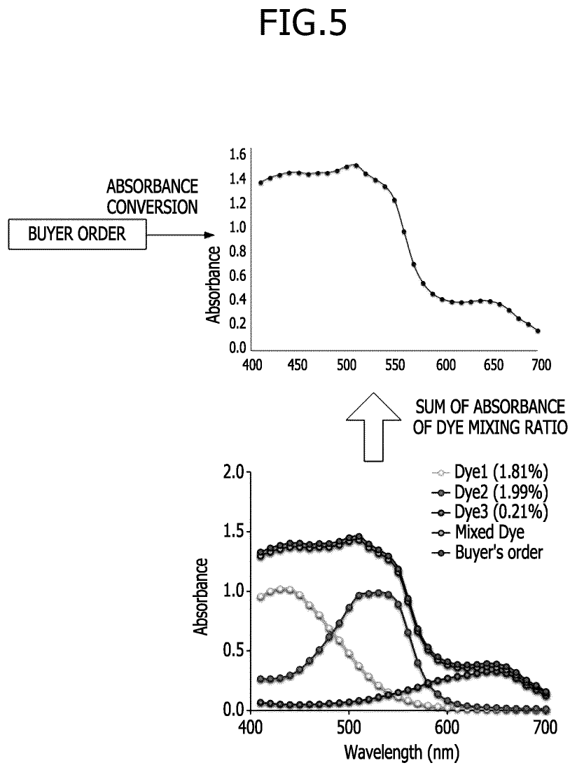

FIG. 5 is a diagram showing an example of matching a buy order absorbance through an absorbance conversion graph for a buy order QTX reflectance and an absorbance graph of an arbitrary dye mixing ratio according to an embodiment of the present invention.

Referring to FIG. 5, the processor 300 converts a buyer order QTX reflectance into absorbance data. To this end, an expression such as absorbance (A)=−log R, absorption rate (% A)=(1/log (% R))+α, or the like may be used.

A color ordered by a buyer is made up of a combination of monochromatic dyes used in dyeing factories by concentration. The combination of the monochromatic dyes by concentration is the dye mixing ratio.

Eventually, the processor 300 reproduces the color requested by the buyer by selecting monochromatic dyes and mixing concentration.

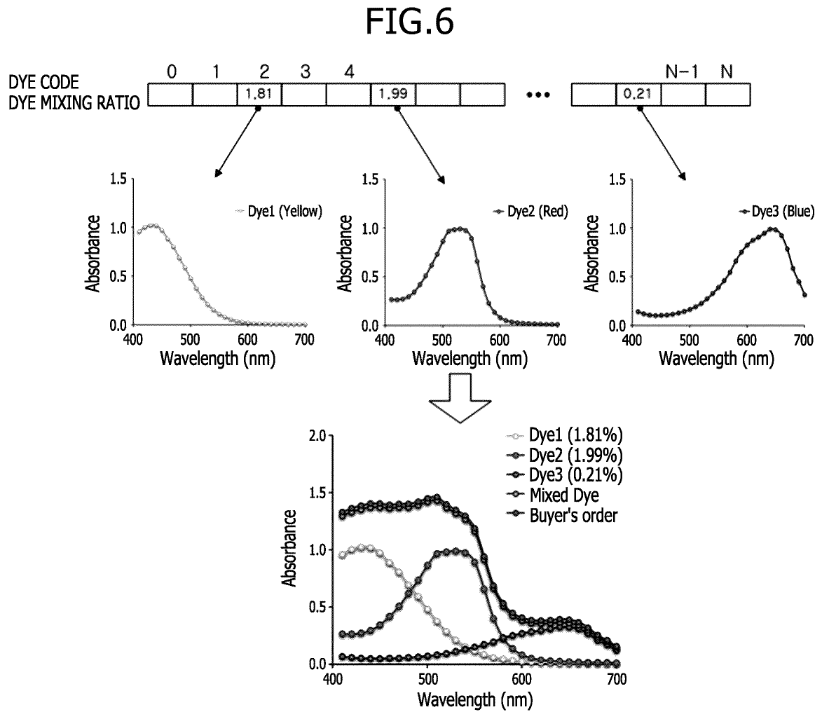

FIG. 6 is a diagram showing absorbance graph conversion according to a dye mixing ratio and an absorbance graph as a mixed dye thereof according to an embodiment of the present invention.

First, dyes may be classified by type. Referring to FIG. 6, examples of the dyes include reactive dyes, disperse dyes, acid dyes, fluorescent dyes, and the like, but there is no case where these types of dyes are cross-mixed with each other. Therefore, the dye mixing ratio may be found depending on the type of dye.

The number of dyes used in dyeing factories varies. Regardless of the number of dyes, a dye code is assigned to each dye, data for the corresponding dye is divided into arrays and named, and values in each array are the ratio values for mixing the corresponding dye. A mixing ratio value of the corresponding dye may be within a set range, for example, from 0.0001% to 8% or 9%. The range used at the dyeing factory site may be applied as the mixing ratio value of the dye, and the mixing ratio value may be set in various ways.

For example, when the mixing ratio of the corresponding dye is 1.81%, absorbance data for the corresponding mixing ratio is calculated by interpolation on the basis of the data used as basic absorbance data.

The basic absorbance data is CCM colorimetric data for each dye concentration that is received from dye companies or generated through CCM colorimetry after dyeing in dyeing factories by themselves.

Generally, the concentration of each dye used as basic data is 0.1%, 0.5%, 1%, 3%, 5%, 8%, or the like. Since it is not possible to dye at all concentrations to generate basic data, the basic data is generated and used for some concentrations.

For the 1.81% concentration, absorbance data for 1.81% according to a wavelength may be obtained by interpolation on the basis of the absorbance data value for each concentration used as the basic data. In this way, a result in which all the pieces of absorbance data according to each dye mixing ratio are obtained and simulation (summation) is performed on the obtained absorbance data is allowed to match the absorbance graph of the color requested by the buyer.

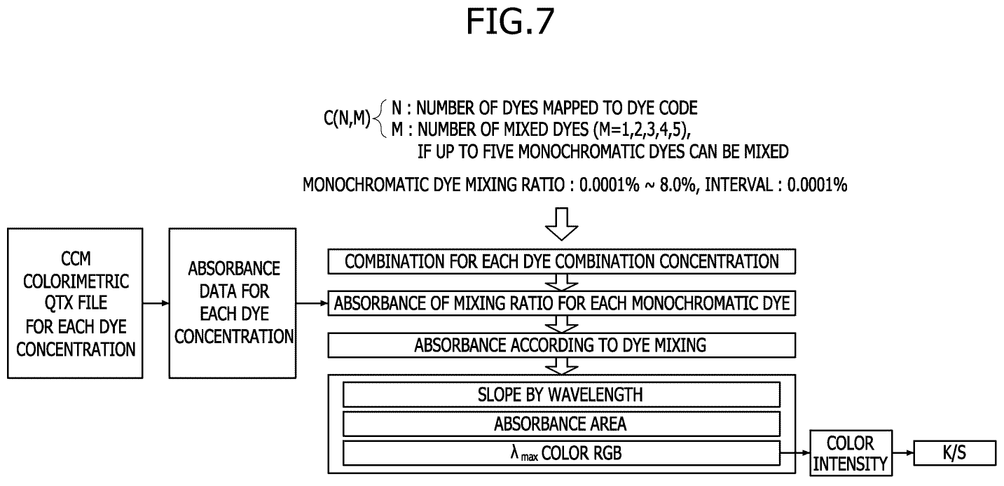

FIG. 7 is a diagram showing a process of generating an absorbance graph and generating a training dataset for the generated absorbance graph according to an embodiment of the present invention, and shows a process of generating absorbance data by calculating the number of cases for dye mixing combinations and generating a training dataset required for training, such as a slope by wavelength, an absorbance area, color RGB values, a color intensity, a K/S, etc., for the absorbance graph.

In the present embodiment, the number of possible combinations compared to the total number of dyes used in dyeing factories is given as examples such as a case of dyeing with a single color, a case of dyeing with a mixture of two dyes, a case of dyeing with a mixture of three dyes, a case of dyeing with a mixture of four dyes, and a case of dyeing with a mixture of five dyes.

In actual dyeing factories, three dyes are most often mixed. The processor 300 may find all the number of cases in which three dyes are combined among the total number of dyes using a combination expression. All possible combinations of dye mixing ratios may be made by listing the number of cases for the corresponding dye combinations and setting the interval from 0.0001% to 8% for each dye to 0.0001%.

When a combination for each concentration according to the dye combination is generated, the processor 300 calculates absorbance data according to the concentration of the monochromatic dyes constituting the corresponding combination.

First, the processor 300 generates basic absorbance data on the basis of basic CCM colorimetry data for each dye concentration that is provided by the dye company or secured through the dyeing factory's own dyeing experiment.

The processor 300 calculates an absorbance according to the mixing ratio of each monochromatic dye by interpolation using the basic absorbance data.

The processor 300 may detect the absorbance according to the mixing ratio for each monochromatic dye by performing simulation with the absorbance data according to the dye mixing ratio.

The processor 300 may calculate a slope for each wavelength section on the basis of the absorbance data according to the dye mixing ratio combination obtained as described above and calculate an absorbance area for a specific wavelength section (400 nm to 700 nm). Further, the processor 300 may obtain color RGB values for λₘₐₓ and calculate a color intensity and a K/S the value on the basis of the color RGB values for λₘₐₓ.

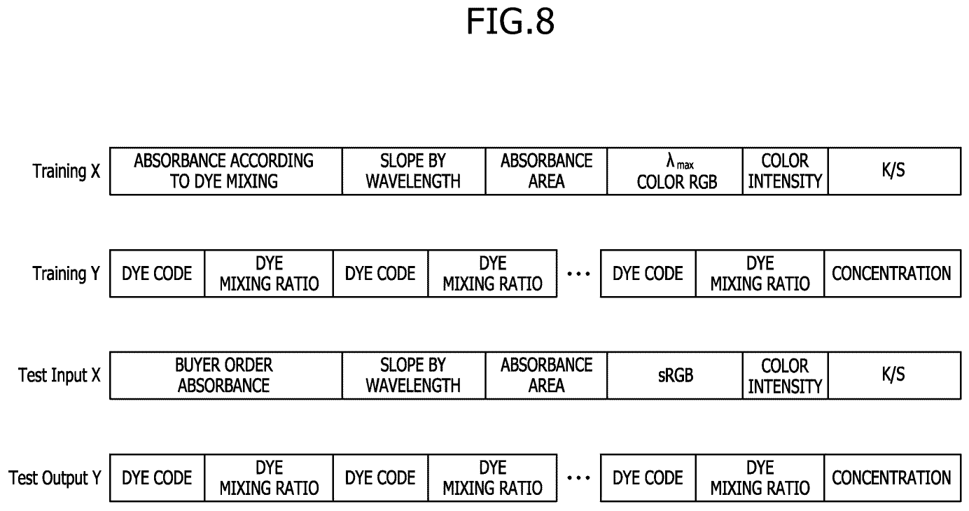

FIG. 8 is a diagram showing a training dataset for training a dye mixing ratio recommendation AI model based on absorbance dataset augmentation according to an embodiment of the present invention.

Referring to FIG. 8, in the training dataset for the AI model, absorbance data according to dye combinations combined through the number of cases, a slope for each wavelength section, an absorbance area, color RGB values for Amax, a color intensity, and a K/S value are taken as X, which is an input value of a training dataset.

An answer sheet by training includes a dye code combined through the number of cases for a dye mixing ratio, a dye mixing ratio, and a concentration.

In the test data, the input data X includes data obtained by converting a buyer order QTX reflectance into an absorbance, a value obtained by converting the slope for each wavelength section, the absorbance area, and the XYZ values into sRGB, and the color intensity and K/S value obtained by being calculated based on the data and the value.

A test output dataset includes the dye code, the dye mixing ratio, and the concentration value.

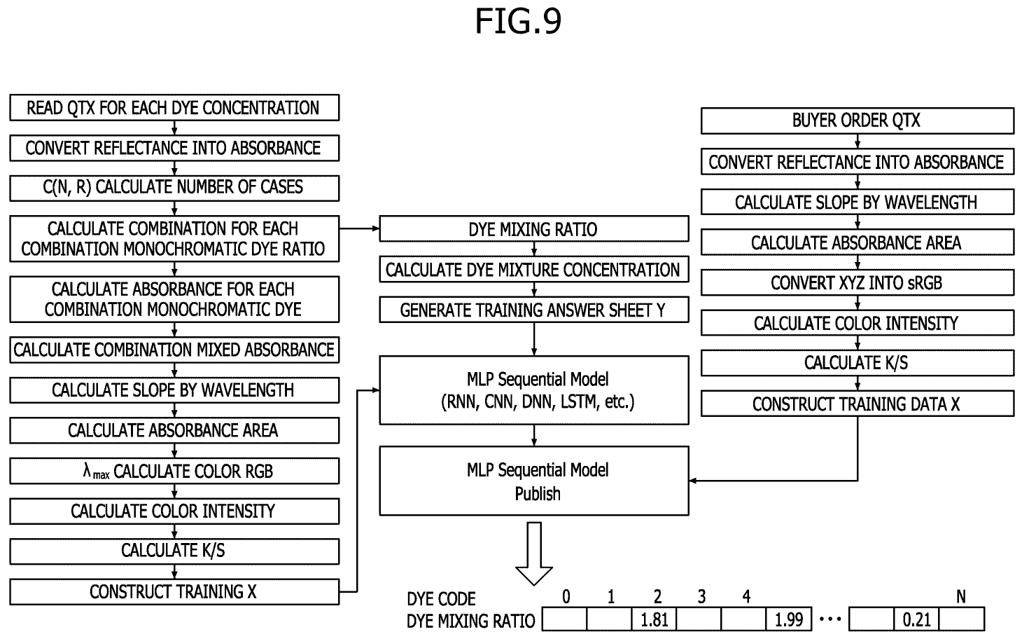

FIG. 9 is a diagram illustrating an AI model according to an embodiment of the present invention.

Referring to FIG. 9, the AI model reads a QTX file for each dye concentration and converts a reflectance into absorbance data.

The AI model uses the absorbance data as basic data for a dye mixing ratio.

The AI model calculates the combination for each monochromatic dye ratio combined by calculating all possible combinations of dye mixing ratios, and calculates the absorbance of the corresponding combination.

The AI model calculates a slope by wavelength and an absorbance area of the mixing combination, calculates color RGB values for λₘₐₓ, a color intensity, and a K/S value, and constructs a training dataset.

The AI model obtains a dye mixing ratio through combination for each monochromatic dye ratio, calculates a dye mixing concentration, constructs an answer sheet for training, and proceeds with training through a multilayer neural network (MLP) AI model.

The AI model in which the training is completed calculates the slope by wavelength, the absorbance area, the sRGB conversion values converted from the XYZ values, the color intensity, and the K/S value from the absorbance data converted from the buyer order QTX, and uses the calculated data as a test dataset to output the dye mixing ratio.

The AI model is an MLP mode, a recurrent neural network (RNN), a convolutional neural network (CNN), a long short-term memory (LSTM) network, or a CNN-LSTM network may be adopted, and the type of AI model is not particularly limited.

The AI model may find a dye mixing ratio using a QTX file that can be obtained from the dye company and the QTX file that is dyed and measured in the dyeing factory itself, and thus the AI model may be used even in dyeing factories that do not have a CCM colorimeter and operating SW.

As described above, the apparatus and method for detecting a dye mixing ratio according to the embodiment of the present invention generates an absorbance graph using a QTX reflectance and detects a dye mixing ratio on the basis of the generated absorbance graph.

The apparatus and method for detecting a dye mixing ratio according to the embodiment of the present invention converts and processes reflectance data affected by light source conditions into absorbance data, and thus metamerism that can be caused by the light source conditions can be reduced.

The apparatus and method for detecting a dye mixing ratio according to the embodiment of the present invention uses an AI model that can output a dye mixing ratio using not only a QTX file that can be provided by a dye company, but also a QTX file generated by a dyeing factory itself, and thus the apparatus and method can be used even in fields without a CCM colorimeter and operating SW.

The apparatus and method for detecting a dye mixing ratio according to the embodiment of the present invention calculates an absorbance graph for a dye mixing ratio in increments of 0.0001% from 0.0001% to 8% for a combination of dyes used in the dyeing factory and uses the absorbance graph as a training dataset, and thus a dye combination and dye mixing ratio with which the color requested by the buyer can be reproduced can be detected with high accuracy.

The apparatus and method for detecting a dye mixing ratio according to the embodiment of the present invention is based on a QTX file provided by the dye company and the QTX file generated through the dyeing factory's own experiment, and thus a dye mixing ratio with which the color requested by the buyer can be reproduced can be detected using only a trained AI model.

The apparatus and method for detecting a dye mixing ratio according to the embodiment of the present invention constructs not only an absorbance converted from a reflectance using an expression, but also a slope by wavelength, an absorbance area, a color intensity, a K/S the value, or the like as training and test datasets, and thus a dye mixing ratio with which the color requested by the buyer can be reproduced can be detected in terms of color intensity and concentration of dyeing.

The apparatus and method for detecting a dye mixing ratio according to the embodiment of the present invention constructs an absorbance, a slope by wavelength, an absorbance area, a color intensity, a K/S value, or the like as a training dataset for a dye mixing ratio recommendation AI model based on absorbance dataset augmentation and recommends a dye mixing ratio through the AI model, and thus the number of B/T tests, experimental dyeing, and bulk dyeing that are repeatedly performed on site in order to reproduce the color requested by the buyer can be reduced, and production costs such as labor, time, dye, water, and energy generated from the above can be reduced.

An apparatus and method for detecting a dye mixing ratio according to an aspect of the present invention generates an absorbance graph using a QTX reflectance and detects a dye mixing ratio on the basis of the generated absorbance graph.

An apparatus and method for detecting a dye mixing ratio according to another aspect of the present invention converts and processes reflectance data affected by light source conditions into absorbance data, and thus metamerism that can be caused by the light source conditions can be reduced.

An apparatus and method for detecting a dye mixing ratio according to still another aspect of the present invention uses an AI model that can output a dye mixing ratio using not only a QTX file that can be provided by a dye company, but also a QTX file generated by a dyeing factory itself, and thus the apparatus and method can be used even in fields without a CCM colorimeter and operating SW.

An apparatus and method for detecting a dye mixing ratio according to yet another aspect of the present invention calculates an absorbance graph for a dye mixing ratio in increments of 0.0001% from 0.0001% to 8% for a combination of dyes used in the dyeing factory and uses the absorbance graph as a training dataset, and thus a dye combination and dye mixing ratio with which the color requested by the buyer can be reproduced can be detected with high accuracy.

An apparatus and method for detecting a dye mixing ratio according to yet another aspect of the present invention is based on a QTX file provided by the dye company and the QTX file generated through the dyeing factory's own experiment, and thus a dye mixing ratio with which the color requested by the buyer can be reproduced can be detected using only a trained AI model.

An apparatus and method for detecting a dye mixing ratio according to yet another aspect of the present invention constructs not only an absorbance converted from a reflectance using an expression, but also a slope by wavelength, an absorbance area, a color intensity, a K/S the value, or the like as training and test datasets, and thus a dye mixing ratio with which the color requested by the buyer can be reproduced can be detected in terms of color intensity and concentration of dyeing.

An apparatus and method for detecting a dye mixing ratio according to yet another aspect of the present invention constructs an absorbance, a slope by wavelength, an absorbance area, a color intensity, a K/S value, or the like as a training dataset for a dye mixing ratio recommendation AI model based on absorbance dataset augmentation and recommends a dye mixing ratio through the AI model, and thus the number of B/T tests, experimental dyeing, and bulk dyeing that are repeatedly performed on site in order to reproduce the color requested by the buyer can be reduced, and production costs such as labor, time, dye, water, and energy generated from the above can be reduced.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. An apparatus for detecting a dye mixing ratio, comprising:
a storage unit configuration to store computer color matching (CCM) colorimetric data for each dye concentration; and
a processor configuration to convert the CCM colorimetric data for each dye concentration store in the storage unit into absorbance data and detect a dye mixing ratio that matches an absorbance graph of a buyer order, on the basis of an artificial intelligence model.

2. The apparatus of claim 1, wherein the CCM colorimetric data for each dye concentration is a CCM colorimetric QuickTime extension (QTX) reflectance for each dye concentration.

3. The apparatus of claim 1, wherein the processor converts a reflectance under buyer-order light source conditions into an absorbance and calculates a slope for each wavelength section of the absorbance data to use the calculated slope as rising and falling trend information of the absorbance graph, and calculates an absorbance area in a specific absorbance wavelength section to use the calculated area as information on a color intensity.

4. The apparatus of claim 1, wherein the processor converts XYZ values under buyer-order light source conditions into standard red, green, and blue (sRGB) values and calculates a color intensity and a K/S value on the basis of the sRGB values.

5. The apparatus of claim 1, wherein the processor generates the absorbance graph on the basis of a ratio of monochromatic dyes, generates an absorbance graph of a mixed dye that is calculated by summation when the monochromatic dyes are mixed, and detects the dye mixing ratio that matches the absorbance graph of the buyer order.

6. The apparatus of claim 1, wherein the processor constructs a training dataset for the artificial intelligence model to train the artificial intelligence model, and applies a test dataset to the artificial intelligence model to detect the dye mixing ratio.

7. The apparatus of claim 6, wherein the training dataset includes at least one of an absorbance according to dye combination, a slope by wavelength, an absorbance area, RGB colors, a color intensity, and a K/S value as an input value of the training dataset, and includes at least one of a dye code, a dye mixing ratio, and a total concentration as an output value of an answer sheet of the training dataset.

8. The apparatus of claim 6, wherein the test dataset includes at least one of a buyer order absorbance, a slope by wavelength, an absorbance area, RGB colors, a color intensity, and a K/S value as an input value of the test dataset, and includes at least one of a dye code, a dye mixing ratio, and a total concentration as an output value of the test dataset.

9. The apparatus of claim 6, wherein the processor converts a reflectance of the CCM colorimetric data for each dye concentration into an absorbance to use the absorbance as basic data for the dye mixing ratio,
calculates the number of possible combinations of dye mixing ratios and calculates a combination for each combined monochromatic dye ratio to construct the training dataset, and
obtains the dye mixing ratio through a combination of the combined monochromatic dye ratios and calculates a dye mixing concentration to construct an answer sheet for training to proceed with training of the artificial intelligence model.

10. The apparatus of claim 1, wherein the processor calculates the number of possible cases with a plurality of dye combinations,
calculates the number of cases for a plurality of concentration intervals for the calculated number of cases,
then calculates an absorbance graph of a monochromatic dye and an absorbance graph of the mixed dye for a dye mixing ratio presented in numbers in each case,
generates a training dataset for the absorbance graph of the mixed dye, and
uses the dye mixing ratio as an answer sheet.

11. A method of detecting a dye mixing ratio, comprising:
collecting, by a processor, computer color matching (CCM) colorimetric data for each dye concentration; and
converting, by the processor, the CCM colorimetric data for each dye concentration into absorbance data and detecting a dye mixing ratio that matches an absorbance graph of a buyer order, on the basis of an artificial intelligence model.

12. The method of claim 11, wherein the CCM colorimetric data for each dye concentration is a CCM colorimetric QuickTime extension (QTX) reflectance for each dye concentration.

13. The method of claim 11, wherein, in the detecting of the dye mixing ratio, the processor converts a reflectance under buyer-order light source conditions into an absorbance and calculates a slope for each wavelength section of the absorbance data to use the calculated slope as rising and falling trend information of the absorbance graph, and calculates an absorbance area in a specific absorbance wavelength section to use the calculated area as information on a color intensity.

14. The method of claim 11, wherein, in the detecting of the dye mixing ratio, the processor converts XYZ values under buyer-order light source conditions into standard red, green, and blue (sRGB) values and calculates a color intensity and a K/S value on the basis of the sRGB values.

15. The method of claim 11, wherein, in the detecting of the dye mixing ratio, the processor generates the absorbance graph on the basis of a ratio of monochromatic dyes, generates an absorbance graph of a mixed dye that is calculated by summation when the monochromatic dyes are mixed, and detects the dye mixing ratio that matches the absorbance graph of the buyer order.

16. The method of claim 11, wherein, in the detecting of the dye mixing ratio, the processor constructs a training dataset for the artificial intelligence model to train the artificial intelligence model, and applies a test dataset to the artificial intelligence model to detect the dye mixing ratio.

17. The method of claim 16, wherein the training dataset includes at least one of an absorbance according to dye combination, a slope by wavelength, an absorbance area, RGB colors, a color intensity, and a K/S value as an input value of the training dataset, and includes at least one of a dye code, a dye mixing ratio, and a total concentration as an output value of an answer sheet of the training dataset.

18. The method of claim 16, wherein the test dataset includes at least one of a buyer order absorbance, a slope by wavelength, an absorbance area, RGB colors, a color intensity, and a K/S value as an input value of the test dataset, and includes at least one of a dye code, a dye mixing ratio, and a total concentration as an output value of the test dataset.

19. The method of claim 16, wherein, in the detecting of the dye mixing ratio, the processor converts a reflectance of the CCM colorimetric data for each dye concentration into an absorbance to use the absorbance as basic data for the dye mixing ratio,
calculates the number of possible combinations of dye mixing ratios and calculates a combination for each combined monochromatic dye ratio to construct the training dataset, and
obtains the dye mixing ratio through a combination of the combined monochromatic dye ratios and calculates a dye mixing concentration to construct an answer sheet for training to proceed with training of the artificial intelligence model.

20. The method of claim 11, wherein, in the detecting of the dye mixing ratio, the processor calculates the number of possible cases with a plurality of dye combinations,
calculates the number of cases for a plurality of concentration intervals for the calculated number of cases,
then calculates an absorbance graph of a monochromatic dye and an absorbance graph of the mixed dye for a dye mixing ratio presented in numbers in each case,
generates a training dataset for the absorbance graph of the mixed dye, and
uses the dye mixing ratio as an answer sheet.
